(19) United States
(12) Patent Application Publication
(10) Pub. No.: US 2009/0162116 A1
(43) Pub. Date: Jun. 25, 2009

(54) IMAGE HEATING APPARATUS

(75) Inventors: Keisuke Mogi, Kashiwa-shi (JP); Seiichiro Kameda, Abiko-shi (JP); Takeshi Fukuda, Nagareyama-shi (JP); Shinichiro Hosoi, Kashiwa-shi (JP); Naoki Hashimoto, Toride-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/329,921

(22) Filed: Dec. 8, 2008

(30) Foreign Application Priority Data
Dec. 20, 2007 (JP) 2007-329201

(51) Int. Cl. G03G 15/20

(52) U.S. Cl. 399/329

(57) ABSTRACT

An image heating apparatus, including: a belt for heating a toner image formed on a sheet in a heating nip portion; a rotary member for forming the heating nip portion in cooperation with the belt and rotating the belt in conjunction with a rotation of the rotary member; a changing device for changing a pressure between the belt and the rotary member; and a warm-up device for starting a rotation of the belt by the rotary member with the pressure between the belt and the rotary member set to a first pressure, and thereafter changing the pressure between the belt and the rotary member from the first pressure to a second pressure higher than the first pressure after a lapse of a predetermined period of time from a start of the rotation of the belt so that the belt is rotated by the rotary member at the second pressure.

### BACKGROUND OF THE INVENTION

1. Field of the Invention

The present invention relates to an image heating apparatus for fixing an image on a sheet in an image forming apparatus such as an electrophotographic apparatus or an electrostatic recording apparatus.

2. Description of the Related Art

In general, the image forming apparatus includes an image heating apparatus for fixing a toner image formed on a sheet through heating or application of pressure. As the above-mentioned image heating apparatus, there is known an apparatus employing a roll fixing system in which a pressure roll is brought into pressure contact with a fixing roll including a heater therein to form a fixing nip portion, thereby performing fixing.

Further, in view of promoting energy saving, there is a film image heating apparatus employing a film heating system, which performs heating through a fixing film having a small heat capacity, as an on-demand system in which heat transfer efficiency is high and rising of the apparatus is fast.

The above-mentioned film image heating apparatus includes a heating member which is fixed and supported, such as a ceramic heater, and a heat-resistant metal film (hereinafter, referred to as fixing film) which serves as a heat transfer member and slides on the heater. The film image heating apparatus further includes an elastic pressure roll for being brought into pressure contact with the heater through the fixing film to form a fixing nip portion serving as a toner image heat fixing region.

In the film image heating apparatus, an unfixed toner image is thermally fused to be fixed onto a recording material by heat of the heater while the recording material bearing the unfixed toner image is nipped and transported between the fixing film and the pressure roll in the fixing nip portion.

In this case, the fixing film is thin and has a small heat capacity and sufficient thermal responsiveness, and thus thermal response of the heater can be reflected in the fixing nip portion nearly as it is, and a fixing temperature is attained in a shorter period of time compared with heating performed by the heater during image heating process, which leads to realization of power saving.

As the film image heating apparatus as described above, there is known an apparatus employing a system in which a dedicated transport roll and a driven roll are used for transporting the fixing film to transport the fixing film between the pressure roll and itself while applying a tension. Besides, there is known another apparatus employing a tensionless system in which a cylindrical fixing film is driven by a transportation force of the pressure roll. In the latter apparatus compared with the former apparatus, an apparatus configuration is simplified to achieve cost reduction.

FIG. 14 illustrates a tensionless-type film image heating apparatus. In this film image heating apparatus, a cylindrical fixing film 23 has heat resistance. A pressure roll 25 serving as a pressure rotary member forms a nip portion N between the fixing film 23 and the pressure roll 25, and causes the fixing film 23 to be rotationally driven. The pressure roll 25 includes an elastic layer 25a having a sufficient releasing ability, such as silicon rubber, and a metal shaft 25b made of SUS or Ni, and causes the fixing film 23 to be rotationally driven by a predetermined pressing force.

In other words, the fixing film 23 is pressed against the pressure roll 25 for pressure fusion of a toner image transferred onto a sheet, and the fixing film 23 is elastically deformed by this pressing. Then, the fixing film 23 and the elastic layer 25a which is an outside diameter portion of the pressure roll 25 are deformed to form the fixing nip portion N to apply heat to the toner. In this case, a nip width of the fixing nip portion N is formed in a direction perpendicular to a pressure direction α of the pressure roll 25, that is, the nip width is formed substantially in parallel to a transportation direction β.

At a portion A which is the most upstream portion of the fixing nip portion N, the pressure roll 25 is brought into contact with the fixing film 23 so that a driving force is transmitted to the fixing film 23 by a frictional force. In a portion B, a nip pressure is formed by the fixing film 23 and the pressure roll 25 deformed by an amount of interference between an original track 23a of the fixing film 23 and the elastic layer 25a of the pressure roll 25.

On this occasion, a static frictional force according to a coefficient of static friction between the fixing film 23 and the elastic layer 25a of the pressure roll 25 is generated, and the generated static frictional force acts in the transportation direction β. The pressure roll 25 is rotated counterclockwise, and thus the pressure roll 25 receives a force in an upstream direction with respect to the transportation direction β as a force opposing the static frictional force, and as a counteraction thereto, the fixing film 23 receives a force in a downstream direction with respect to the transportation direction β. This force acts in the whole that forms the fixing nip portion N in proportion to a volume of the pressing force, and causes the fixing film 23 to be rotationally driven.

FIG. 15 illustrates a rotary track of the fixing film 23, and a track F1 illustrates a case where the fixing film 23 is rotated in the state in which the image heating apparatus is not sufficiently warmed, for example, immediately after power-on of the main body. A track F2 illustrates a case where the image heating apparatus is sufficiently warmed.

Referring to FIG. 15, it is revealed that the fixing film 23 follows the track on a downstream side when its temperature is lower. This is because in a portion C in which the fixing film 23 is separated from the pressure roll 25, the fixing film 23 is released from constraint of the pressure roll 25 in the state in which the fixing film 23 has a resultant force in the transportation direction β, with the result that, on this occasion, the fixing film 23 overruns (hereinafter, referred to as flutters) due to inertia force of the fixing film 23. The flutter is particularly conspicuous when the image heating apparatus is awakened from its sleep mode, or at rising at first early in the morning, in which the image apparatus is not warmed.

It should be noted that, in FIG. 15, a separation guide 29 is provided in the vicinity of the fixing film 23 and separates the sheet from the fixing film 23. A gap G represents a gap between the fixing film 23 and the separation guide 29 when the image heating apparatus is warmed.

However, in the conventional film image heating apparatus, flutter eliminates a clearance between the fixing film 23 and the separation guide 29 located on the downstream side thereof. In the worst case, the interference between the fixing film 23 and a member provided in the vicinity of the fixing film 23, such as the separation guide 29, damages the surface of the fixing film 23 to cause a poor image. Moreover, when the fixing film 23 is heated and the elastic layer 25a and the metal shaft 25b of the pressure roll 25 are softened, the inertia force of the fixing film 23 is reduced, and hence the flutter thereof is reduced.

Further, wrapping jam of the sheet is likely to occur in the film image heating apparatus. In particular, when a full-color image having a relatively large toner bearing amount is fixed or a thin sheet or an absorbent sheet having relatively low stiffness is fixed, wrapping jam to the fixing sheet 23 is likely to occur.

Under the circumstances, when a position of the separation guide 29 is determined in consideration of the flutter, the gap G between the separation guide 29 and the fixing film 23 becomes unnecessarily large after the flutter of the fixing film 23 is reduced, which leads to a fear that poor separation may occur.

### SUMMARY OF THE INVENTION

The present invention provides an image heating apparatus in which a contact between a fixing film and a member provided in the vicinity of the fixing film is avoided, and a sheet separation performance is increased.

Further, the present invention provides an image heating apparatus, comprising: a belt for heating a toner image formed on a sheet in a heating nip portion; a rotary member for forming the heating nip portion between the belt and the rotary member and rotating the belt in conjunction with a rotation of the rotary member; changing means for changing a pressure between the belt and the rotary member; and warm-up means for starting a rotation of the belt by the rotary member in a state where the pressure between the belt and the rotary member is set to a first pressure, and thereafter changing the pressure between the belt and the rotary member from the first pressure to a second pressure higher than the first pressure after a lapse of a predetermined period of time from a start of the rotation of the belt so that the belt is rotated by the rotary member at the second pressure.

Still further, the present invention provides an image heating apparatus, comprising: a belt for heating a toner image formed on a sheet in a heating nip portion; a rotary member for forming the heating nip portion between the belt and the rotary member and rotating the belt in conjunction with a rotation of the rotary member; changing means for changing a pressure between the belt and the rotary member; and warm-up means for starting a rotation of the belt by the rotary member in a state where the pressure between the belt and the rotary member is set to a first pressure, and thereafter changing the pressure between the belt and the rotary member from the first pressure to a second pressure higher than the first pressure after a temperature of the belt becomes higher than a predetermined temperature so that the belt is rotated by the rotary member at the second pressure.

Further features of the present invention become apparent from the following description of an exemplary embodiment with reference to the attached drawings.

### BRIEF DESCRIPTION OF THE DRAWINGS

FIG. 1 is a cross-sectional view of an image heating apparatus according to an embodiment of the present invention.

FIG. 2 is a cross-sectional view of the image heating apparatus of FIG. 1 in proximity to a fixing film sliding portion.

FIG. 3 is a front view of the image heating apparatus of FIG. 1.

FIG. 4 is a cross-sectional view of one end portion of the image heating apparatus of FIG. 1.

FIG. 5 is a cross-sectional view of the other end portion of the image heating apparatus of FIG. 1.

FIG. 6 is an explanatory diagram of a pressure cam of the image heating apparatus of FIG. 1.

FIG. 7 is a flowchart for explaining a rising operation of the image heating apparatus of FIG. 1.

FIG. 8 is a characteristic diagram illustrating a relationship between a phase of the pressure cam and a pressing force of the image heating apparatus of FIG. 1.

FIG. 9 is an explanatory view of the rising operation of the image heating apparatus of FIG. 1 when a heater temperature T is larger than T1.

FIG. 10 is another explanatory diagram of the rising operation of the image heating apparatus of FIG. 1 when the heater temperature T is smaller than T1.

FIG. 11 is a diagram in which a gap between a distal end of a separation guide and the fixing film is recorded in time-series when the rising operation of the image heating apparatus of FIG. 1 is performed at a pressing force P1.

FIG. 12 is a diagram in which the gap between the distal end of the separation guide and the fixing film is recorded in time-series when the rising operation of the image heating apparatus of FIG. 1 is performed at a pressing force PG.

FIG. 13 is a table illustrating a relationship between the gap and presence/absence of wrapping jam.

FIG. 14 is a diagram for explaining a force acting on a fixing film of a tensionless-type image heating apparatus.

FIG. 15 is a graph illustrating a track of the fixing film in proximity to the separation guide.

FIG. 16 is a cross-sectional view of a main body of an image forming apparatus including the image heating apparatus according to the present invention.

FIG. 17 is a block diagram illustrating a control portion according to the present invention.

### DESCRIPTION OF THE EMBODIMENT

A preferred embodiment of the present invention will now be described in detail in accordance with the accompanying drawings.

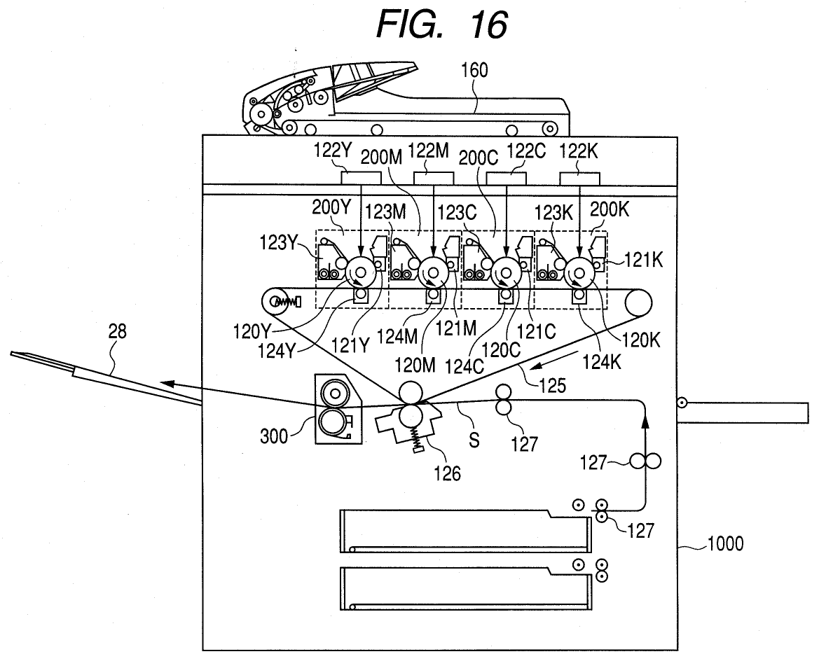

FIG. 16 illustrates a structure of an apparatus main body 1000 of an image forming apparatus including a fixing apparatus 300 serving as an image heating apparatus according to the present invention. It should be noted that the image forming apparatus employing a full-color intermediate transfer system is illustrated as a specific example, but the present invention is not limited thereto.

The apparatus main body 1000 includes, for example, image bearing members 120Y, 120, 120C, and 120K which bear on respective surfaces thereof electrostatic latent images correspondingly to toner images of four colors, that is, yellow (Y), magenta (M), cyan (C), and black (K), respectively. Hereinafter, for simplicity of description, those four image bearing members are denoted by representative reference numeral 120, and charging means, exposing means, developing means, and the like, which are described below, are denoted by representative reference numerals in the same manner.

The surfaces of the four image bearing members 120 are uniformly charged to have a required potential by primary charging means 121 and then are exposed by exposing means 122, whereby electrostatic latent images are formed on those image bearing members 120. Then, the electrostatic latent images formed on the image bearing members 120 are developed by developing devices 123 using developers to be visualized as toner images.

As illustrated in FIG. 16, image forming means 200Y, 200M, 200C, and 200K are disposed in series correspondingly to formation of the four color toner images in the apparatus main body 1000, and a tandem system in which the processes until the images are visualized are performed in parallel for respective colors is adopted.

The toner images formed on the image bearing members 120, which are developed by the developing devices 123, are primarily transferred and sequentially superimposed on an intermediate transfer member 125, which is an endless belt, by a primary transfer device 124. Then, the toner images of the respective colors, which are primarily transferred on the intermediate transfer member 125, are collectively transferred on a sheet S by a secondary transfer device 126. The sheet S is transported to the secondary transfer device 126 by a sheet feeding device 127. After the secondary transfer, the sheet S bearing an unfixed toner image is transported to the fixing apparatus (image heating apparatus) 300 according to this embodiment, which employs a belt system, and is heated and pressed by a pressure by the fixing apparatus 300, whereby the unfixed toner image is fused and softened to be fixed. Then, the sheet is delivered to a delivery tray 28 after being fixed.

As described above, a series of image formation process of charging, exposing, developing, transferring, and fixing is performed, whereby an image is recorded and formed on the sheet S. It should be noted that, in the case of a monochrome image forming apparatus, only image forming means for black is provided. An order of arranging image forming means for colors of Y, M, C, and K or their structures are not limited thereto.

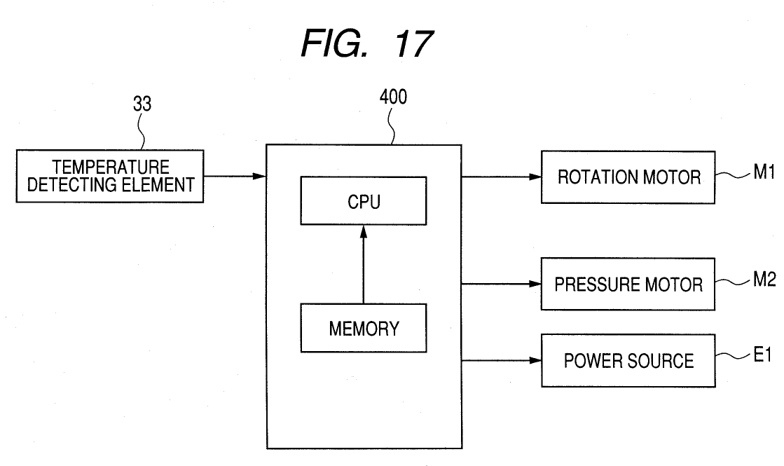

It should be noted that entire system control of the apparatus main body 1000 including the fixing apparatus 300, which is described next, is collectively performed by a control portion 400 illustrated in FIG. 17. The control portion 400 includes a central processing unit (CPU) and a memory capable of saving, writing, and storing various items of information or data, and reading them.

The control portion 400 functions as warm-up process performing means for performing “warm-up process” described later, which is the gist of this embodiment.

Then, the fixing apparatus 300 provided as the image heating apparatus in the apparatus main body 1000 of this embodiment will be described.

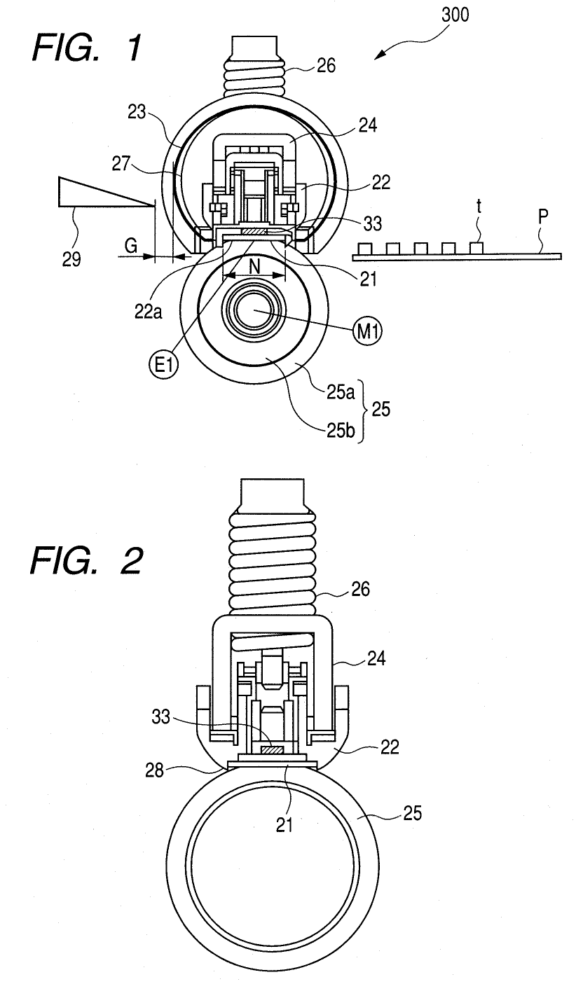

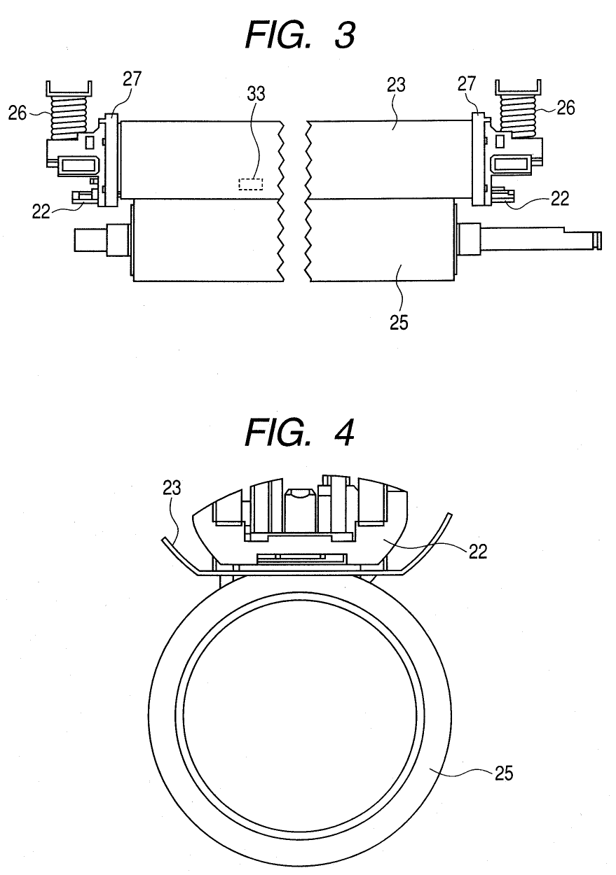

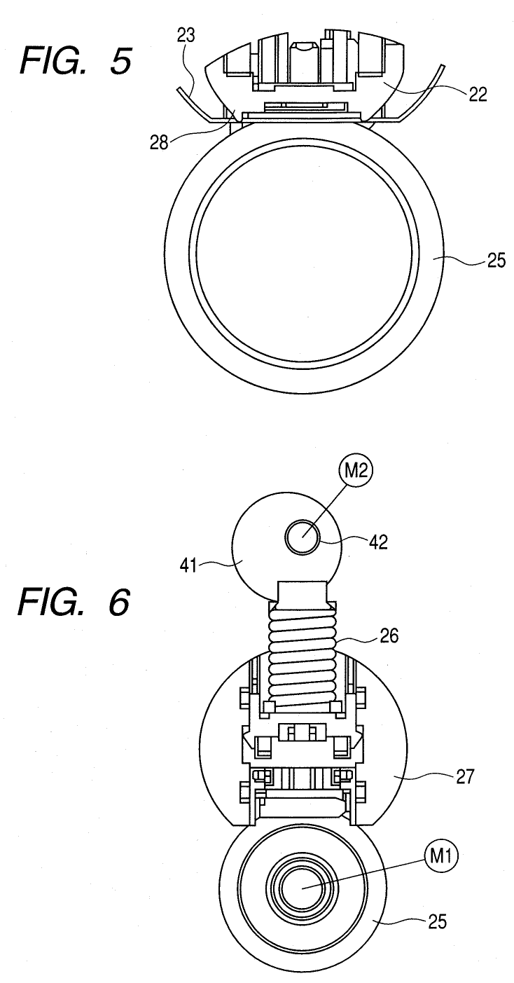

FIG. 1 is a cross-sectional view of the fixing apparatus 300 of this embodiment. FIG. 2 is a cross-sectional view of the fixing apparatus in the vicinity of a fixing film sliding portion, and FIG. 3 is a front view of the film image heating apparatus. FIG. 4 is a cross-sectional view of one end portion of the film image heating apparatus, and FIG. 5 is a cross-sectional view of the other end portion of the film image heating apparatus.

In the tensionless-type fixing apparatus 300 employing a film heating system illustrated in FIGS. 1 to 5, a ceramic heater (hereinafter, referred to as heater) 21 serving as a heating member includes, as basic components, an elongated thin-plate-like ceramic substrate and a heating resistor layer provided to a surface of the ceramic substrate, which is a low-heat-capacity heater whose temperature is increased overall because of its steep rising characteristic through energization from a power source E1 to the heating resistor layer.

A laterally elongated support member 22 fixes and supports the heater 21. The support member 22 is a heat-insulating member having a cross-section of a substantially semicircular-arc-like trough-shape, such as a heat-resistant resin. The heater 21 is fixed by a heat-resistant adhesive or the like so as to expose its bottom surface to a groove portion 22a formed in a lower portion of the support member 22 in a longitudinal direction thereof.

On a surface on the support member side of the heater 21, a temperature detecting element 33 serving as temperature detecting means such as a thermistor for detecting a heater temperature is provided as heating member temperature detecting means. A fixing film 23 is a heat-resistant endless belt serving as a heating member which transmits heat. The fixing film 23 is externally fitted to the support member 22 including the heater 21 in a loose manner, and is slidably rotated on the surface of the heater 21. The temperature detecting element 33 detects the heater temperature to detect a temperature of the fixing film 23.

The fixing film 23 is a composite layered film including a metal layer, an elastic layer formed on an outer circumferential surface of the metal layer, and a coating of about 5 to 50 μm of Poly Tetrafluoro Ethylene (PTFE), Perfluoro Alkoxy resins (PFA), Fluorinated Ethylene Propylene (FEP), or the like coated on an outer circumferential surface of the elastic layer, in which heat capacity is reduced to improve a quick-start characteristic. It should be noted that the metal layer is made of SUS or Ni having a thickness of 100 μm or less, and preferably about 20 to 50 μm, and the elastic layer is made of a heat-resistant rubber such as silicon rubber and fluororubber, or a foam of silicon rubber.

At least a part of a perimeter of the fixing film 23 is always kept in tension-free, i.e., in the state devoid of application of tension, and the fixing film 23 is rotated in conjunction with a rotation of a pressure roll, which is described later, by a rotational driving force of the pressure roll.

A stay 24 is provided inside the support member 22 and supports the support member 22. A heat-resistant elastic pressure roll (rotary member) 25 serving as a pressure member is formed of a metal shaft 25b made of SUS or Ni and an elastic layer 25a made of a heat-resistant rubber such as silicon rubber and flouororubber, or a foam of silicon rubber, and both end portions of the metal shaft 25b are rotatably supported. The pressure roll 25 is rotationally driven by a rotation motor M1 connected to the metal shaft 25b.

An assembly of the heater 21, the support member 22, the fixing film 23, and the stay 24 is disposed on the pressure roll 25 in parallel with the heater 21, with the heater 21 facing downward, and the stay 24 is pressed downward by an urging member 26. Accordingly, a bottom surface of the heater 21 is pressed on the pressure roll 25 against the elasticity of the elastic layer 25a of the pressure roll 25 through the fixing film 23, whereby a fixing nip portion N serving as the heating nip portion, which becomes the heating portion, is formed.

A flange member 27 is provided by being fitted to the both end portions of the cylindrical support member 22. The flange member 27 supports both end portions of the fixing film 23, thereby restricting a lateral movement of the fixing film 23 along a longitudinal direction of the support member 22.

Further, in order to improve a sheet separation characteristic of a sheet P from the fixing film 23, the support member 22 is provided with a protruding portion 28. The protruding portion 28 is located on a downstream side in a movement direction of the sheet P with respect to a sliding portion between the heater 21 and the fixing film 23, and protrudes to the pressure roll 25 side.

It is sufficient that a protruding amount of the protruding portion 28 is 0.1 mm or more and 1.0 mm or less with respect to the sliding surface between the heater 21 and the fixing film 23. This is because the sheet separation characteristic becomes insufficient when the protruding amount is less than 0.1 mm, which leads to occurrence of wrapping jam in the image heating apparatus 300.

When the protruding amount is larger than 1.0 mm, a curl amount of the fixed sheet P becomes considerably large. Further, in the case of using a metal member as the fixing film 23, a bending stress to the fixing film 23 increases as the protruding amount becomes larger, whereby fatigue breakdown of the metal member is likely to occur. Therefore, the protruding amount may be desirably 0.5 mm or less. In this embodiment, the protruding amount is set to 0.3 mm.

The separation guide 29 is a noncontact separation member. The separation guide 29 is disposed on a transportation downstream side of the sheet P so as to have a predetermined gap G between the fixing film 23 and itself so that the delivered sheet P is prevented from wrapping around the fixing belt and that the separation guide 29 is prevented from being brought into contact with the fixing film 23 to damage the fixing film 23. In FIG. 6, a pressure cam 41 serving as pressing force varying means is rotatably supported by a decentered shaft 42. A pressing force of the fixing nip portion N becomes variable when the pressure cam 41 is rotationally driven by a pressure motor M2.

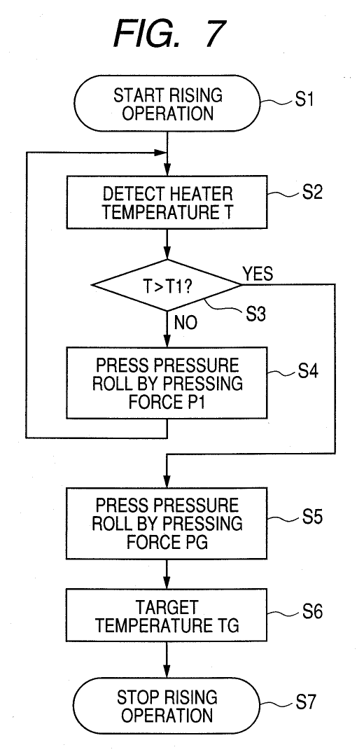

Next, a rising operation of the fixing apparatus 300 is described with reference to a flowchart illustrated in FIG. 7.

First, when power is supplied to the fixing apparatus 300, the rising operation thereof is started (Step S1). The temperature detecting element 33 detects a heater temperature T (temperature of the fixing film 23) at the start of the rising operation (Step S2). Then, the heater temperature T is compared with a predetermined temperature T1 (Step S3). In the case where the heater temperature T is lower than the predetermined temperature T1, the pressure cam 41 is rotated by the pressure motor M1, and the pressure roll 25 is pressed by a pressing force P (first pressure) while the heater 21 being energized from the power source E1 to increase its temperature (Step S4). Further, the pressure roll 25 is driven at a predetermined rotation speed by the rotation motor M2.

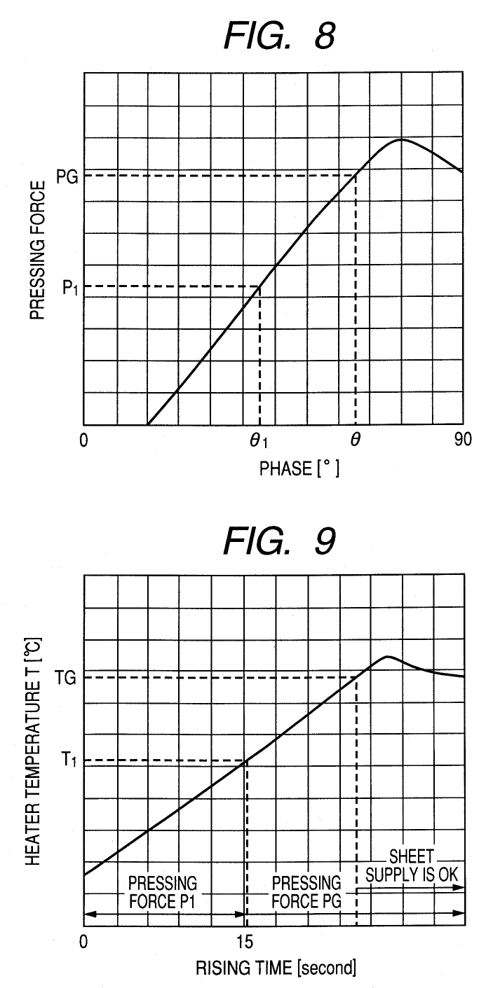

On this occasion, a phase of the pressure cam 41 and a pressing force are, for example, in a relationship illustrated in FIG. 8. In the case of the pressing force P, the phase of the pressure cam 41 is maintained at θ1, and the pressing force P is lower than a pressing force (second pressure) during normal sheet supply, that is, when the toner image formed on the sheet is heated. Then, a force applied to the fixing film 23 in a transportation direction β is determined by multiplying a force applied to the fixing film 23 in a pressure direction α, which becomes a vertical stress, by a coefficient of static friction between the fixing film 23 and the elastic layer 25a of the pressure roll 25.

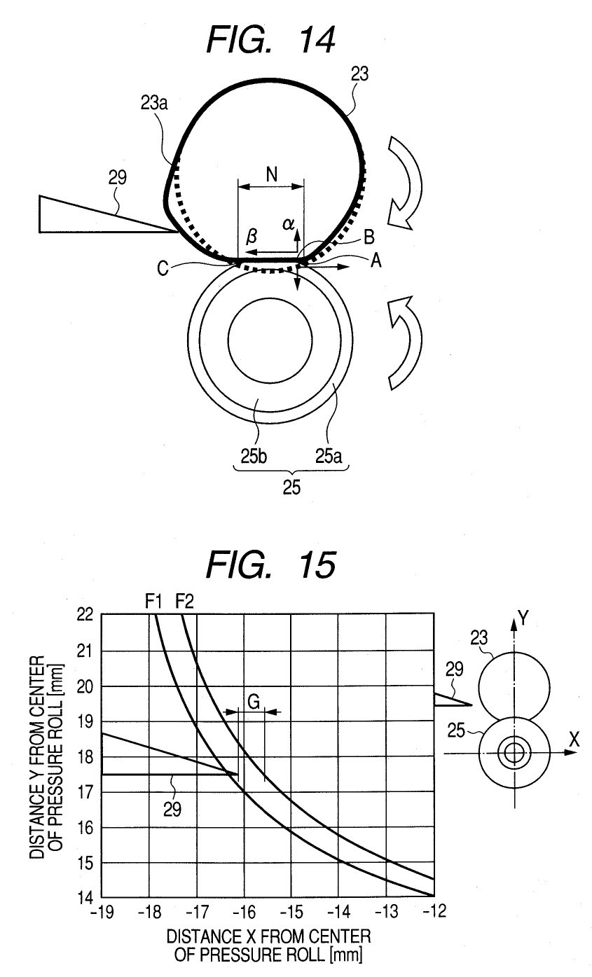

Therefore, compared with the case where the rising operation is performed at the normal pressing force, the force applied to the fixing film 23 in the transportation direction β can be reduced to be small. Accordingly, when the fixing film 23 is released from the fixing nip portion N at the portion C, a phenomenon in which the fixing film 23 inflates toward the downstream side in the transportation direction can be reduced to be small (see FIG. 14).

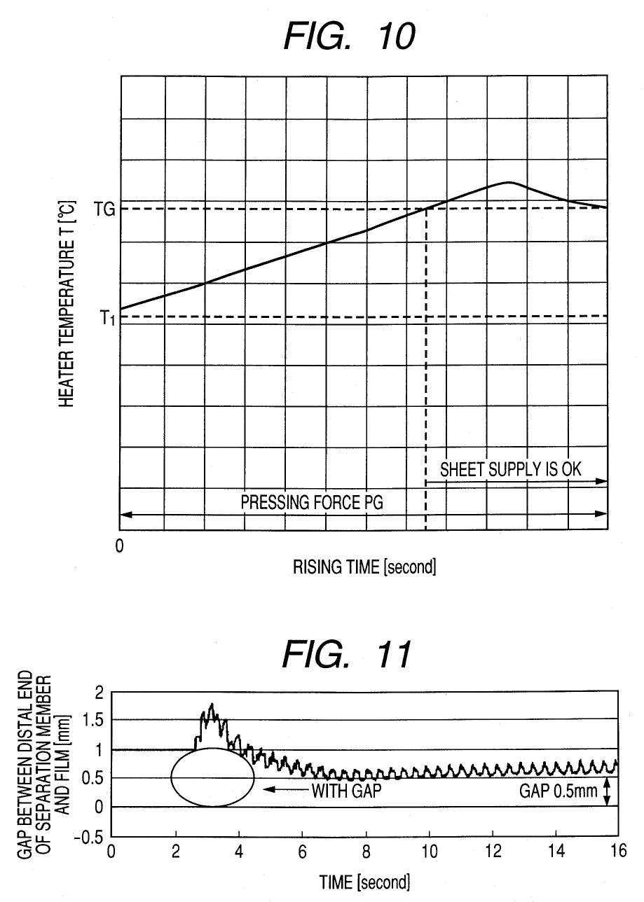

The rising operation is summarized as in FIG. 9 and FIG. 10. Specifically, in the case where the heater temperature T is larger than T1 after a lapse of a predetermined period of time from the start of the rotation of the fixing film 23 (see FIG. 9), or if the heater temperature T is already larger than T1 at the start of the rising operation (see FIG. 10), the pressure cam 41 is operated, and the pressure roll 25 is pressed by a normal pressing force PG (Step S5). It should be noted that, in this case, there is a relationship in which PG is larger than P1. The pressing force PG is a pressure between the fixing film 23 and the pressure roll 25 when the toner image formed on the sheet S is heated in the fixing nip portion N.

Thereafter, the heater temperature T becomes a target temperature TG (Step S6), and the rising operation is stopped (Step S7). It should be noted that the target temperature TG is the heater temperature T when the toner image formed on the sheet S is heated in the fixing nip portion N.

In other words, when a detected temperature of the fixing film 23 is increased to the predetermined temperature after a lapse of a predetermined period of time from the start of the rotation of the fixing film 23, the pressure between the fixing film 23 and the pressure roll 25 is changed to a high pressure, and the fixing film 23 is rotated at the high pressure. The operation as described above is performed by the control unit 400 serving as the warm-up process performing means illustrated in FIG. 17.

In this state, the sheet P bearing an unfixed toner image “t” is introduced between the fixing film 23 and the pressure roll 25 of the fixing nip portion N. Then, a surface on the toner-image-bearing side of the sheet P is brought into intimate contact with an outer surface of the fixing film 23, is heated, and is pressed in the fixing nip portion N.

After that, the unfixed toner image “t” formed on the sheet P is fusion-fixed on the sheet P. The sheet P that has passed through the fixing nip portion N is self stripped from the fixing film 23 by the separation guide 29 to be delivered and transported.

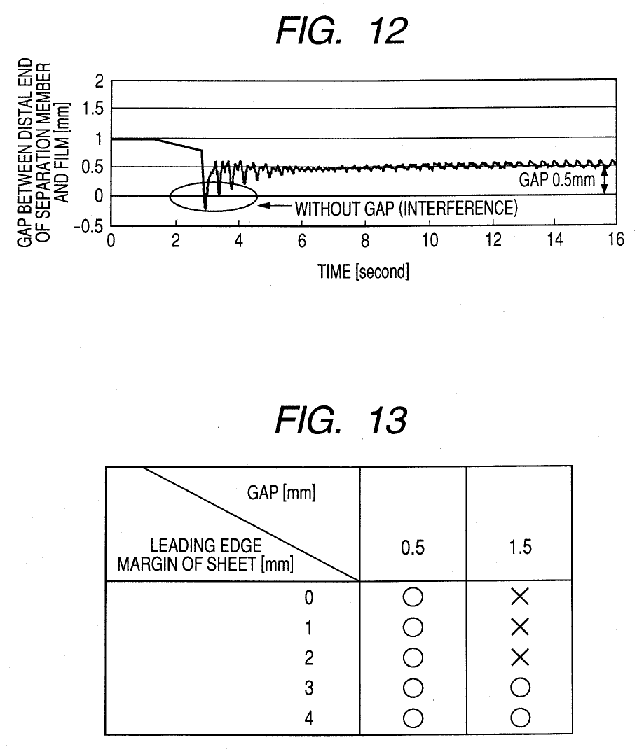

In this embodiment, in the case where T1=120 (° C.), TG=230 (° C.), P1=160 (N), and PG=320 (N), a track of the fixing film 23 when the fixing apparatus is risen at the pressing force P1 becomes as illustrated in FIG. 11. As apparent from FIG. 12, the flutter of the fixing film 23 can be suppressed compared with the track of the fixing film 23 when the fixing apparatus is risen at the pressing force PG from the early stage of the rising operation. In other words, a gap G between the separation guide 29 and the fixing film 23 can be reduced compared with the conventional case.

Besides, a relationship between the gap G and presence/absence of wrapping jam when the temperature was controlled was confirmed. Its results are illustrated in FIG. 13 (∘: No jam occurs. ×: Jam occurs). It should be noted that the conditions checked at this time are as follows.

Environment: room temperature of 30° C., humidity of 80%

Sheet type: Canon-manufactured, EN100 (64 g/m²)

Sheet size: A4

Image: bearing amount of 1.10 (mg/mm²)

Specifically, according to this embodiment in which a pressing force is controlled, the flutter can be suppressed, enabling the separation guide 29 to be provided and set in the vicinity of the fixing film 23. Accordingly, it is revealed that even when a full-color image having a relatively large toner bearing amount is fixed or even in the case of thin paper or absorbent paper having relatively low stiffness, wrapping jam to the fixing film 23 can be prevented.

Further, contact between the fixing film 23 and the separation guide 29 is avoided, and damage to the fixing film 23 or poor image can be prevented. Moreover, separation performance of the sheet P is increased, to thereby improve the transport performance of the sheet P.

While the present invention has been described with reference to the exemplary embodiment, it is to be understood that the invention is not limited to the disclosed exemplary embodiment. The scope of the following claims is to be accorded the broadest interpretation so as to encompass all such modifications and equivalent structures and functions.

For example, in this embodiment, the pressing force at the time of rising is the pressing force P1, which is used only at the time of rising. However, in the case where a pressing force reduction mode such as a thin paper mode is provided, a pressing force that is best suited thereto may be used to perform rising.

This application claims the benefit of Japanese Patent Application No. 2007-329201, filed Dec. 20, 2007, which is hereby incorporated by reference herein in its entirety.

What is claimed is:

1. An image heating apparatus, comprising:
a belt for heating a toner image formed on a sheet in a heating nip portion;
a rotary member for forming the heating nip portion between the belt and the rotary member and rotating the belt in conjunction with a rotation of the rotary member;
changing means for changing a pressure between the belt and the rotary member; and
warm-up means for starting a rotation of the belt by the rotary member in a state where the pressure between the belt and the rotary member is set to a first pressure, and thereafter changing the pressure between the belt and the rotary member from the first pressure to a second pressure higher than the first pressure after a lapse of a predetermined period of time from a start of the rotation of the belt so that the belt is rotated by the rotary member at the second pressure.

2. An image heating apparatus according to claim 1, wherein the first pressure is smaller than the pressure between the belt and the rotary member when the toner image formed on the sheet is heated in the heating nip portion.

3. An image heating apparatus according to claim 2, further comprising a noncontact separation member for separating the sheet from the belt.

4. An image heating apparatus, comprising:
a belt for heating a toner image formed on a sheet in a heating nip portion;
a rotary member for forming the heating nip portion between the belt and the rotary member and rotating the belt in conjunction with a rotation of the rotary member;
changing means for changing a pressure between the belt and the rotary member; and
warm-up means for starting a rotation of the belt by the rotary member in a state where the pressure between the belt and the rotary member is set to a first pressure, and thereafter changing the pressure between the belt and the rotary member from the first pressure to a second pressure higher than the first pressure after a temperature of the belt becomes higher than a predetermined temperature so that the belt is rotated by the rotary member at the second pressure.

5. An image heating apparatus according to claim 4, wherein the predetermined temperature is lower than the temperature of the belt when the toner image formed on the sheet is heated in the heating nip portion.

6. An image heating apparatus according to claim 5, further comprising temperature detecting means for detecting the temperature of the belt,
wherein the warm-up means changes the pressure between the belt and the rotary member from the first pressure to the second pressure based on a detection result made by the temperature detecting means.
